(19) United States
(12) Patent Application Publication
(10) Pub. No.: US 2006/0008610 A1
(43) Pub. Date: Jan. 12, 2006

(54) Device for fabricating plastic plates

(76) Inventors: Jesse Hsu, Taichung Hsien (TW); Danison Ho, Yung-Kang (TW)

Correspondence Address: G' LINK COMPANY, Suite 137, PMB 174, 931 West 75th Street, Naperville, IL, 60565, US

(21) Appl. No.: 10/883,694

(22) Filed: Jul. 6, 2004

(51) Int. Cl. B32B 1/04

(52) U.S. Cl. 428/69

(57) ABSTRACT

A device for fabricating plastic plates includes a divider, a plurality of extruders, a die, a cooling vacuum forming mold and a conveyer. The divider provides a driving mechanism to move the divider back and forth with a reset speed controlled by a cam motor or step motor operated with program. The extruders are connected to the divider. The die is connected to the divider and the cooling vacuum mold is disposed next to the die. The conveyor is disposed next to the cooling vacuum mold. The molten plastic material can be squeezed into divider via the extruders and treated by the die and the cooling vacuum forming mold after being agitated in a heating cylinder to constitute different layers inside. The plastic plates can be pulled out with the conveyor after being made in different curves. Multi-layer plastics can be added in different proportions to enhance effects such as anti abrupt piercing, anti air leak, anti elongation, anti-shock, corrosion resistance, acid resistance, alkali resistance, insulation resistance, chemical resistance and color change resistance.

### BACKGROUND OF THE INVENTION

I. Field of the Invention

The present invention is related to device for fabricating plastic plates and particularly to device for fabricating plastic plates with multi-layer gas barrier.

2. Brief Description of Related Art:

The extruder is usually used for making plastic products and the melting plastic material is squeezed with the extruder to form various plastic products. The plastic products can be provided with various cross sections such as rod, pipe, film or plate as continuous products. Taking the plate shaped continuous products as an example, the manufacturing process with regard to squeezing forming has four steps:

(1) Pour the powder or particle thermoplastic material into a hopper;

(2) The plastic material in the hopper falls into a heating cylinder with revolving screw and a driving motor actuates the revolving screw to rotate about an axis so that the plastic material is liquefied due to heat generated from the revolving screw and device of heating unit. The temperature of the heating cylinder is between 180˜485° F.

(3) The plastic material passes through the heating cylinder and is pushed outward under a pressure between 100˜2,500 psi to be formed a shape after moving over a forming die of the heating cylinder. The cross section of the forming die has decided the shape and size of the finished product. This part is called mold hole.

(4) The finished product is pulled out with pull-off device and cooling section and becomes harden gradually. Finally, the finished product is cut into proper length.

Referring to FIG. 1, the plastic plate A has two plate members A1, A2 and a plurality of line shaped reinforced ribs A3, which are arranged between the plate members A1, A2. The plate members A1, A2 are capable of standing pressure due to aid of the reinforce rib A3 so that the plastic plate A is largely used as indoor building material such as window and door guard or for making various box products.

The plastic plate A basically can resist ordinary foreign forces but are subjected to different pressure resistances at different directions. When a foreign force is exerted along a direction perpendicular to the reinforce ribs A3 to bend the plastic plate A, the plastic plate A is capable of keeping unchanged from being deformed due to the foreign force is evenly supported by the reinforce ribs A3.

Further, when the foreign force is exerted along a direction parallel to the reinforce ribs A3 to bend the plastic plate A, the plate members A1, A2 at locations between any two adjacent reinforce ribs is bent and deformed and even becomes fracture. This is the serious deficiency of the plastic plate A.

Referring to FIGS. 2 and 3 in company with FIG. 1 again, Taiwanese Patent Gazette No. 545377 (application No. 90215603) is illustrated. The plastic material is placed in a heating cylinder B3 to be heated up to a state of melting and the molten plastic material is agitated with a revolving screw B4 till even consistency is reached. Then, the molten plastic material is squeezed into a forming mold tool B5 and the mold tool B5 is provided with a flow opening B50 to press the plastic material into a plastic plate B2. Next, a shape device B6 is used to move back and forth a distance with a controlled speed so that the plastic plate B2 can be formed as a shape of sine curve after leaving the soled mold tool. Finally, a conveyer B9 pulls the plastic plate B2 outward gradually and the conveyer B9 has a detecting circuit B12. The plastic plate B2 provides two plate members B20, B21 and a plurality of reinforce ribs B22, which are disposed between the plate members B20, B21. The reinforce ribs B22 also constitutes a sine curve shape. Under this circumference, the plastic plate B2 is incapable of being bent and deformed due to the reinforce ribs dispersing the foreign force when the plastic plate is subjected to bending forces from any directions.

The preceding device for fabricating the plastic plate has the following shortcomings:

(1) The Finished Plastic Plate is Hard to Keep Flat:

While the molten plastic material is squeezed to form a plastic plate, the plastic plate has not hardened yet. A shaper moves back and forth a distance with a proper speed to treat the plastic plate so that the plastic plate has a shape of sine wave after leaving the mold tool. However, it is hard to keep the produced plastic plate in flatness while the conventional device is utilized to fabricate the plastic plate.

(2) The Plastic Plate is Made of Single Material Only and it is Unable to Meet Required Economic Effect:

The conventional device merely fabricates the plastic plate with single material so that, for instance, a plastic partition needed by a building is require to provide property of anti-inflammation and plastic material with property of anti-inflammation is specially required before the plastic partition is made. However, making a plastic plate for specific purpose with the conventional device costs high production expense. That is, the conventional device is unable to fabricate a plastic plate satisfying different needs such as preventions of abrupt piercing, air leak and providing properties such as anti-elongation, anti-shock, corrosion resistance, acid resistance, alkali resistance and insulation resistance.

### SUMMARY OF THE INVENTION

The crux of the present invention is to provide a device for fabricating plastic plates with which each of the fabricated plastic plates has multi-layers in different materials and offers a function of gas barrier with gases such as O2, N2, CO, CO2 and etc.

The device for fabricating plastic plates according to the present invention includes a divider and the divider connects with a plurality of extruder. The plastic material is placed in a heating cylinder for being heated to a state of melting. Then, the molten plastic material is evenly agitated to an extent of consistency before being pushed to the extruders. Afterwards, the molten plastic material is forced to enter the divider. A driving mechanism is attached to the divider to be controlled with a cam motor or step motor, which is can be reset with a specific cycle by way of computer program, so that the divider can be pushed back and forth in a controlled speed during making the plastic plate. The plastic plate has different curves after being worked with a die and a cooling vacuum forming mold and is pulled with a roller/conveyor cooling section.

Furthermore, it is capable of performing extrusion for single or multiple layers as required such that plastic plates in different curves and properties can be formed as needed. The plastic material can be combined with a tie layer in different proportions such that the finished product can prevent from abrupt piercing and air leak and provide properties such as anti-elongation, anti-shock, corrosion resistance, acid resistance, alkali resistance, insulation resistance, inflammation resistance, anti-chemical agent and color change resistance with rigid flexible material.

The plastic plate made by way of the device according to the present invention can provide better flat crush strength and prolong time duration for air ventilation and water penetration. Hence, an effect of gas barrier can be obtained effectively.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a plastic plate made with a conventional fabricating device;

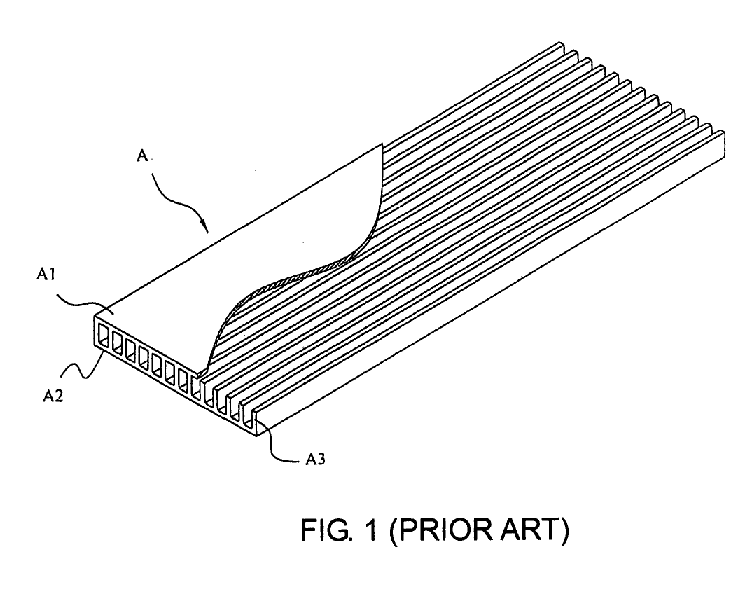

FIG. 2 is a perspective view of a plastic plate with curve shape;

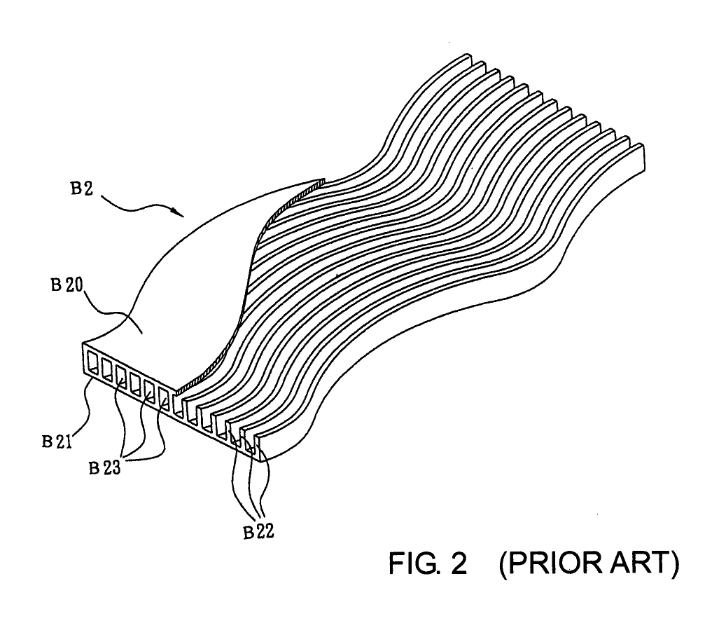

FIG. 3 is a partly block diagram illustrating the conventional device for making the plastic plate;

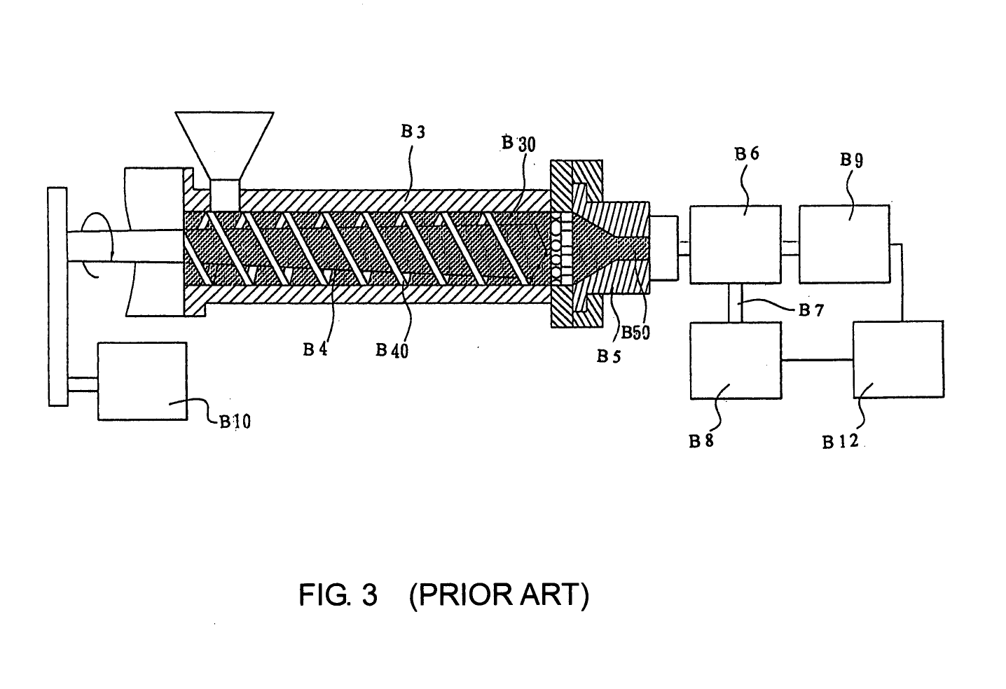

FIG. 4 is a plan view of a device for fabricating a plastic plate according to the present invention;

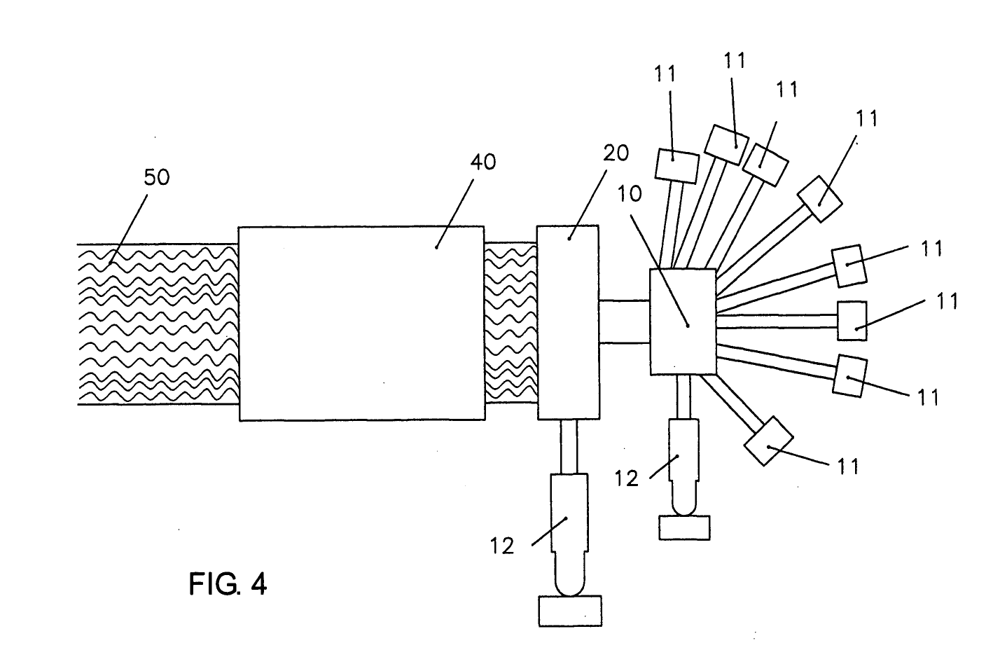

FIG. 5 is a graph of a sine curve applied by the device for fabricating a plastic plate according to the present invention; and

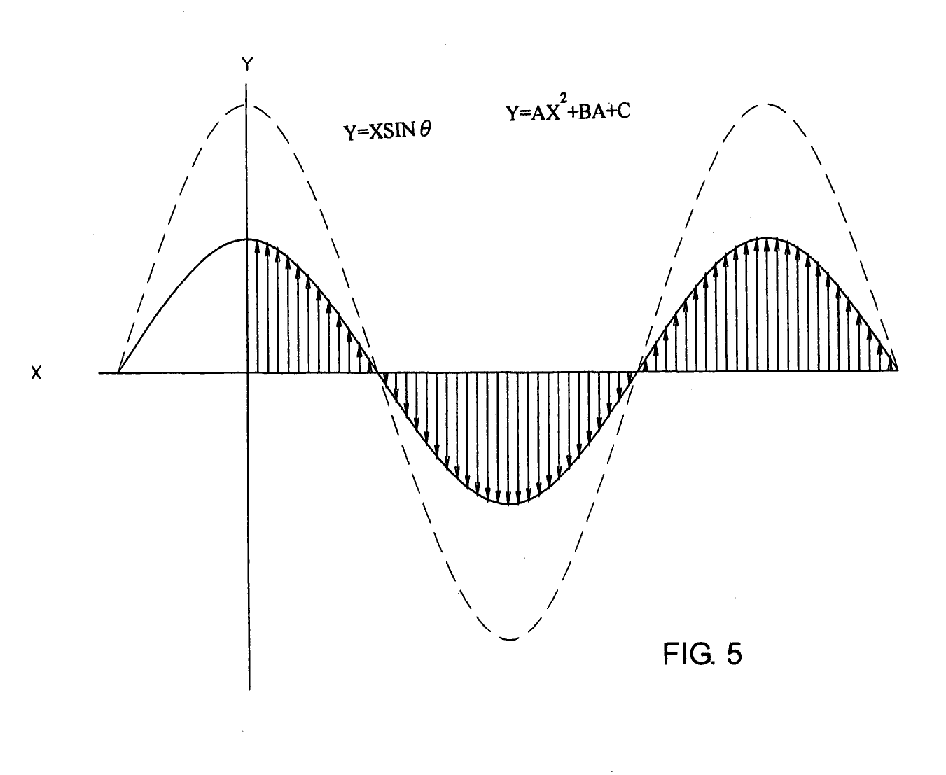

FIG. 6 is a cross section of the divider in the device according to the present invention.

### DETAILED DESCRIPTION OF THE PREFERRED EMBODIMENT

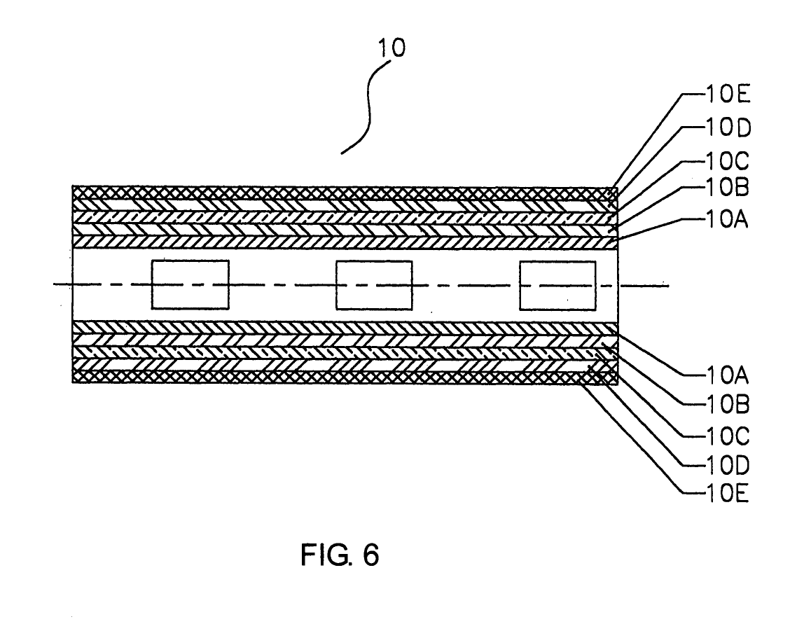

Referring to FIG. 6, the device for fabricating a plastic plate provides a divider 10, which allows extruded layers complying with single axis, double axes, three axes, five axes, seven axes, nine axes or eleven axes to enhance performance of the gas barrier and strength between layers so as to prevent the plastic plate from being broken and leaking.

A driving mechanism 12, which is under the divider 10 and the die 20 respectively, can be reset to perform different cycles with control of a cam motor or step motor by way of computer program so as to make bent plastic plates in different curves. The driving mechanism 12 provides continuous arc surfaces at the front section thereof for moving and bending the plastic plate so as to allow the plastic plate obtaining a smooth surface.

Different kinds of plastic materials can be fed to the divider 10 based on need. After being formed with the die 20 and the refrigerated vacuum mold 40, proper layers in the plastic plate can be formed and the plastic materials can be joined to the tie layers in different proportions to enhance the effects such as anti abrupt piercing, anti air leak, anti elongation, anti-shock, corrosion resistance, acid resistance, alkali resistance, insulation resistance, anti-chemical agent and color change resistance.

The Method for Extrusion and Layer Division:

Different sizes of extruders are designed to control temperature and thickness of each layer via the divider or each extruding model so as to obtain a proportion, which is can reach best economic effect.

An example: a sectional view of the divider 10 is illustrated in FIG. 6. The divider 10 provides the innermost layer 10A being HDPE, the second layer 10B being a tie layer, the third layer 10C being nylon, the fourth layer 10D being another tie layer, the fifth layer 10E being ABS. Further, a proper color can be chosen to enhance the sense of beauty. Each of the plastic layers can be acrylic, cellulosics, fluorocarbons, polyethylene, vinyls, PC, PP. MDPE, LDPE, LLDPE, C6, C8, POF, PVC, EPDM and the like. Different proportions of tie can be arranged with the plastic materials or a single layer of tie can be used for mixing with the plastic materials before being extruded.

The Implement of Making the Bend Plate:

By using speed rate control with left and right movements in company with the divider and the leading speed applying the curve principle of Y=X SIN θ and Y2=AX2+BX+CY, the program processor of the step motor forms the material as a regular bending shape before the material enters the vacuum mold. Once the bending shape is formed, anti-shock capability of the lateral sides of the formed material increases 20˜30%. Further, the front side of the formed material also can enhance the anti-shock capability due to density of jut spots being increased.

The plastic plate of the present invention can be worked as non-recyclable container and is suitable for being made as a hollow stuff and filling with special gas so as to constitute base material of a special heat guider for being heat up. For example:

It is suitable for being filled with and packing super conductor. Hence, it is a revolutionary change from using copper, which is conventionally used as the conductive material, to speed up effect of simple material and low cost.

Steps: 1.PA, EVOH, PVDC and PET are belonged to high air blocked plastic material and it is possible to be joined with various fluidic materials, which provide M1 between 0.025 and 15. The tie layer can be combined with low cost and high strength materials such as PP, HDPE/LDPE, LLDEP, C4, C6, C8, MLLDPE and the like. The proportion is between 0˜99% and fusion via extruding base with temperature range of 120˜380° C. The process is from divider or single axis feeder to T-Die.

T-Die is provided with multi-layer structure (1, 3, 7, 9, 11 and etc.) and the combined materials can be formed as a desired shape via the program stir wheel and left and right moving speed of the control mold after being extruded. The extruded thickness is between 0.5˜30 mm after the materials are treated with air cooling at the first time and ice cold forming at the second time.

While the invention has been described with referencing to preferred embodiments thereof, it is to be understood that modifications or variations may be easily made without departing from the spirit of this invention, which is defined by the appended claims.

What is claimed is:

1. A device for fabricating plastic plates, comprising:
a divider, providing a driving mechanism to move the divider back and forth with a set speed;
a plurality of extruders, being connected to the divider;
a die, being connected to the divider;
a refrigerant vacuum mold, being disposed next to the die; and
a conveyer, being disposed next to the vacuum mold;
whereby, molten plastic material can be squeezed into divider via the extruders after being agitated in a heating cylinder and treated by the die and the cooling vacuum forming mold; and the plastic plates, which are made in different curves, can be pulled out with the roller/conveyor device.

2. The device for fabricating plastic plates as defined in claim 1, wherein another driving mechanism can be provided on the die.

3. The device for fabricating plastic plates as defined in claim 1, wherein the divider and the die are provided with a driving mechanism respectively.

4. The device for fabricating plastic plates as defined in claim 1, wherein the driving device is controlled with a cam motor, which can be reset different cycles by way of a computer program.

5. The device for fabricating plastic plates as defined in claim 2, wherein the driving device is controlled with a cam motor, which can be reset different cycles by way of a computer program.

6. The device for fabricating plastic plates as defined in claim 1, wherein the driving device is controlled with a cam motor, which can be reset different cycles by way of a computer program.

7. The device for fabricating plastic plates as defined in claim 1, wherein the driving mechanism is controlled with a step motor.

8. The device for fabricating plastic plates as defined in claim 2, wherein the driving mechanism is controlled with a step motor.

9. The device for fabricating plastic plates as defined in claim 3, wherein the driving mechanism is controlled with a step motor.

10. The device for fabricating plastic plates as defined in claim 1, wherein the divider can match with at least a single axis for connecting with extruding layers of different extruder so as to enhance effect of gas barrier and strength between layers for providing strength and chemical resistance property enhancement.

11. The device for fabricating plastic plates as defined in claim 1, wherein the cooling vacuum mold is a heating type.

12. The device for fabricating plastic plates as defined in claim 1, wherein material of the plastic plates is acrylic.

13. The device for fabricating plastic plates as defined in claim 1, wherein material of the plastic plates is cellulosics.

14. The device for fabricating plastic plates as defined in claim 1, wherein material of the plastic plates is fluorocarbon.

15. The device for fabricating plastic plates as defined in claim 1, wherein material of the plastic plates is nylon.

16. The device for fabricating plastic plates as defined in claim 1, wherein material of the plastic plates is polyethylene, which includes LDPE, LLDPE (such as C4, C6 and C8), VLDPE, HDPE and MDPE.

17. The device for fabricating plastic plates as defined in claim 1, wherein material of the plastic plates is vinyls.

18. The device for fabricating plastic plates as defined in claim 1, wherein material of the plastic plates is PC.

19. The device for fabricating plastic plates as defined in claim 1, wherein material of the plastic plates is PP, which includes Co-PP and Homo-PP.

20. The device for fabricating plastic plates as defined in claim 1, wherein material of the plastic plates is ABS.

21. The device for fabricating plastic plates as defined in claim 1, wherein material of the plastic plates is POF, which is a mixture of PP and PE.

22. The device for fabricating plastic plates as defined in claim 1, wherein material of the plastic plates is PVC.

23. The device for fabricating plastic plates as defined in claim 1, wherein material of the plastic plates is EPDM.

24. The device for fabricating plastic plates as defined in claim 1, wherein material of the plastic plates is PET, PA (nylon), PA 6, PA 666 or EVOH.

25. The device for fabricating plastic plates as defined in claim 1, wherein material of the plastic plates can be different plastic material in different proportions.

26. The device for fabricating plastic plates as defined in claim 1, wherein material of the plastic plates can be ordinary chemical polymer matching with tie layer in different proportion.
